(19) United States
(12) Patent Application Publication
(10) Pub. No.: US 2006/0290690 A1
(43) Pub. Date: Dec. 28, 2006

(54) Display apparatus

(76) Inventor: Young-ho Ahn, Seoul (KR)

Correspondence Address: STANZIONE & KIM, LLP, 919 18TH STREET, N.W., SUITE 440, WASHINGTON, DC, 20006, US

(21) Appl. No.: 11/374,090

(22) Filed: Mar. 14, 2006

(30) Foreign Application Priority Data
Jun. 25, 2005 (KR) 2005-55350

(51) Int. Cl. G09G 5/00

(52) U.S. Cl. 345/211

(57) ABSTRACT

A display apparatus includes a display part, a video signal processor to convert an input video signal into a format displayable by the display part, a network controller to be connected to a network and to transmit and receive data according to a predetermined protocol, a data processor to process data transmitted and received through the network controller and to output a predetermined power saving mode conversion signal, and a controller to convert an operation mode of the display apparatus into a preset power saving mode when the predetermined power saving mode conversion signal is received from the data processor. Thus, the display apparatus, which transmits and receives data through a network, reduces power consumption.

### CROSS-REFERENCE TO RELATED APPLICATIONS

This application claims the benefit under 35 U.S.C. §119 of Korean Patent Application No. 2005-55350, filed on Jun. 25, 2005, in the Korean Intellectual Property Office, the disclosure of which is incorporated herein by reference in its entirety.

### BACKGROUND OF THE INVENTION

1. Field of the Invention

The present general inventive concept relates to a display apparatus, and more particularly, to a display apparatus, which transmits and receives data through a network, and reduces power consumption.

2. Description of the Related Art

Generally, a display apparatus includes a liquid crystal display (LCD), a plasma display panel (PDP), etc. The display apparatus is employed as a monitor of a TV or a computer to display images thereon.

If the display apparatus is used as a monitor, the display apparatus performs various functions such as receiving TV broadcast signals through a tuner and displaying them thereon, outputting sound signals from the computer through an attached speaker, and displaying video signals received from the computer thereon as images. Such a monitor having various functions is referred to as a multi-function monitor.

Meanwhile, monitors and computers are connected to each other through a D-Sub connector or a DVI connector to allow the video signals from the computer to be transmitted to the monitor.

The multi-function monitor may comprise an S-video connector, a component connector or a composite connector, as well as the D-Sub connector or the DVI connector mentioned above, to receive a video signal from external devices such as a digital video disk (DVD) player or a videocassette recorder (VCR).

Also, the computer has more than a single output connector, such as the D-Sub connector, that is, the computer has two or more output connectors, such as the D-Sub connector, the DVI connector, the S-video connector, etc. Thus, the computer may be connected with two or more monitors.

The recent multi-function monitor provides various functions such as displaying data received through the network as images, sending and receiving a predetermined control signal through the network, as well as being connected with the computer through a video cable.

Meanwhile, various power saving modes are provided to reduce power consumption of the multi-function monitor. For example, according to a display power management signaling (DPMS) of video electronics standard association (VESA), the multi-function monitor is converted into a power saving mode depending on conditions of the video signals received from the computer (e.g., according to whether a synchronous signal is supplied).

However, the multi-function monitor having the network function does not have an additional power saving mode when processing data received through the network.

It becomes necessary to provide a monitor having the network function to operate in a power saving mode according to operating conditions of the monitor and to reduce power consumption thereof.

### SUMMARY OF THE INVENTION

The present general inventive concept provides a display apparatus, which transmits and receives data through a network, and reduces power consumption.

Additional aspects and/or advantages of the present general inventive concept will be set forth in part in the description which follows and, in part, will be obvious from the description, or may be learned by practice of the present general inventive concept.

The foregoing and/or other aspects of the present general inventive concept are achieved by providing a display apparatus comprising a display part, a video signal processor to convert an input video signal into a format displayable by the display part, a network controller to be connected to a network and to transmit and receive data according to a predetermined protocol, a data processor to process the data transmitted and received through the network controller and to output a predetermined power saving mode conversion signal, and a controller to convert an operation mode of the display apparatus into a preset power saving mode when the predetermined power saving mode conversion signal is received from the data processor.

The display part may comprise a liquid crystal display (LCD) panel, and a backlight unit to emit light toward the LCD panel, and the controller turns off the backlight unit according to the received predetermined power saving mode conversion signal.

The controller may convert the operation mode of the display apparatus into a normal mode if a normal mode conversion signal is received from the data processor when the display apparatus is in the power saving mode.

The data processor may comprise a data storage part to store at least one control routine therein to process the data received through the network controller, a memory to load the at least one control routine and an operating system, a main processor to load the at least one control routine to the memory and to execute the at least one control routine, and a bridge circuit to allow the data storage part and the main processor to communicate with each other.

The controller may be connected with the bridge circuit, and the main processor may selectively supply the predetermined power saving mode conversion signal and the normal mode conversion signal to the controller through the bridge circuit.

The main processor may supply one of the predetermined power saving mode conversion signal and the normal mode conversion signal to the controller based on a predetermined control signal received through the network controller from an external device connected through the network.

The display apparatus may further comprise a video input part to receive a first video signal in a predetermined format, wherein the controller operates in a first display mode to control the video signal processor to display the first video signal on the display part as an image, and operates in a second display mode to control the video signal processor to display a second video signal in the predetermined format output from the data processor, on the display part as an image.

The controller may control the display apparatus to remain in the normal mode if the predetermined power saving mode conversion signal is received from the data processor when the controller operates in the first display mode, and to convert into the preset power saving mode if the predetermined power saving mode conversion signal is received from the data processor when the controller operates in the second display mode.

The controller may convert the display apparatus in the preset power saving mode according to a state of the first video signal input through the video input part while operating in the first display mode.

The preset power saving mode according to the state of the first video signal may comprise a display power management signaling (DPMS) of video electronics standard association (VESA).

The foregoing and/or other aspects of the present general inventive concept are also achieved by providing a video signal processing and control system usable with a display that displays video signals received from a network, the video signal processing and control system including a controller to receive first data from the network, to extract and transmit a first video signal included in the first data to the display, and to send a power save signal to the display depending on the first data.

The foregoing and/or other aspects of the present general inventive concept are also achieved by providing a display connected to a network, the display including a display part to display images according to video signals, and a video signal processing and control unit to receive first data from the network, to extract a first video signal included in the first data received, to send the first video signal to the display part, and to send a power save signal to the display part when the first data is not received from the network for a predetermined period of time, and when a power saving command is included in the first data.

The foregoing and/or other aspects of the present general inventive concept are also achieved by providing a computer readable medium containing executable code of to control a display connected to a network, the executable codes including a first executable code to receive data from the network and extract a video signal from the data, a second executable code to transmit the video signal to the display, and a third executable code to send a power save signal to the display depending on the first data.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a connection between a display apparatus according to an embodiment of the present general inventive concept and a computer; and

FIGS. 2 and 3 are control block diagrams of the display apparatus of FIG. 1.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

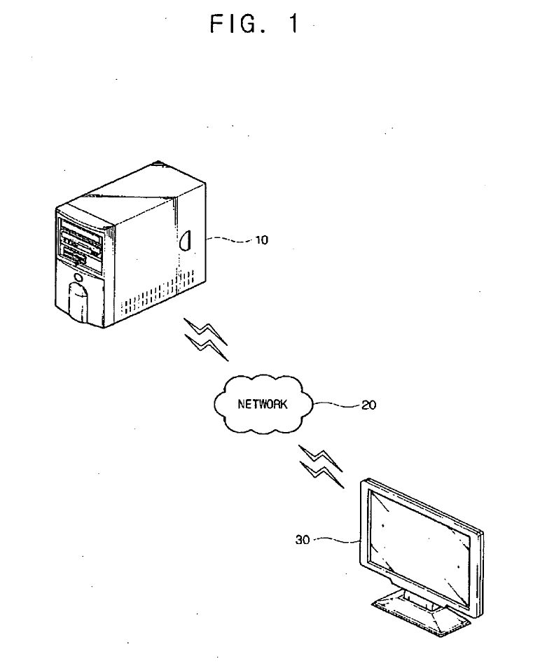

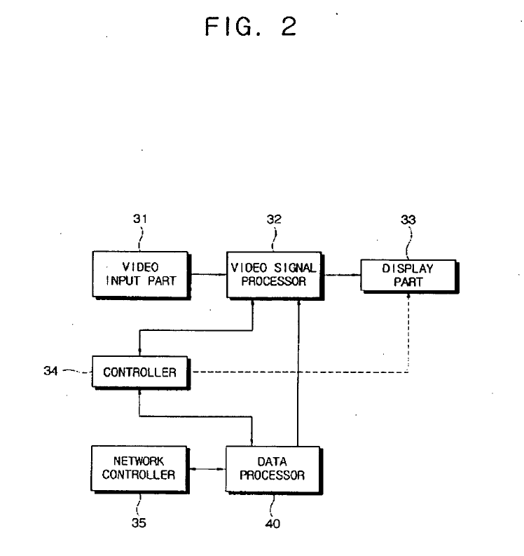

As illustrated in FIG. 1, a display apparatus 30 according to an embodiment of the present general inventive concept is connected with an external device, e.g., with a computer 10 through a network 20. The display apparatus 30 according to the present embodiment may further comprise a video input part 31 to connect with the computer 10 through a video cable to transmit a video signal from the computer 10 to the display apparatus 30 according to a predetermined video format, as illustrated in FIG. 2. Here, the video input part 31 may comprise at least one of a D-Sub connector, a DVI connector, a S-video connector, a component connector and a composite connector.

Referring to FIG. 2, the display apparatus 30 according to the present embodiment further comprises a display part 33, a video signal processor 32, a network controller 35, a data processor 40 and a controller 34.

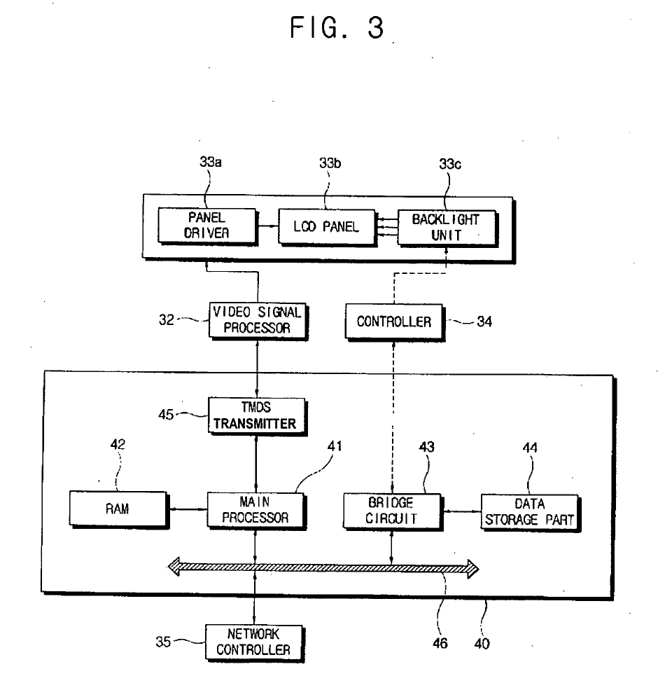

The display part 33 displays the video signal received from the video signal processor 32 as an image thereon. As illustrated in FIG. 3, the display part 33 according to the present embodiment employs a liquid crystal display (LCD) comprising a liquid crystal display (LCD) panel 33b and a backlight unit 33c to emit light toward the LCD panel 33b, as an illustration of the present embodiment. However, it should be understood that the above-described embodiment of the display part is merely illustrative and is not intended to be limiting to the present general inventive concept. According to the embodiment illustrated in FIG. 3, the display part 33 comprises a panel driver 33a to drive the LCD panel 33b according to the video signal from the video signal processor 32.

The video signal processor 32 converts the video signal input from the video input part 31 or the data processor 40 into a format displayable by the display part 33 before supplying the video signal to the display part 33. The video signal supplied from the video input part 31 to the video signal processor 32 is referred to as a first video signal. The video signal supplied from the data processor 40 to the video signal processor 32 is referred to as a second video signal.

The video signal processor 32 may be provided in various forms corresponding to various formats of the input video signal. For example, the video signal processor 32 may comprise a scaler, and a video signal converter to convert the first video signal received in various formats, which is input through the video input part 31 in a format processible by the scaler.

Here, the video signal converter 32 may comprise at least one of an A/D converter, a video decoder and a tuner, corresponding to the various formats in which the first video signal may be received. The scaler converts the video signal output from the video signal converter to conform to a vertical frequency, resolution, an image ratio of output standards of the display part 33.

The network controller 35 is connected to the network 20 to send and receive data according to a predetermined protocol. The network controller 35 according to the present embodiment may be connected with the computer 10 through a local area network (LAN) wirelessly or through a network cable. Also, the network controller 35 may be connected with the computer 10 using other methods, such as infrared communication or bluetooth, as long as the network controller communicates with the computer 10.

The data processor 40 processes the data transmitted and received through the network controller 35. The data processor 40 outputs a power saving mode conversion signal according to predetermined conditions.

The controller 34 controls the video signal processor 32 and the display part 33 to display the image on the display part 33. Also, the controller 34 controls the display apparatus 30 to convert the display apparatus 30 into a preset power saving mode according to the received power saving mode conversion signal if the power saving mode conversion signal is received from the data processor 40.

Hereinafter, the display apparatus 30 according to an embodiment of the present general inventive concept will be described in detail with reference to FIG. 3.

The data processor 40 according to the present embodiment may comprise a data storage part 44, a RAM 42 as a memory, a main processor 41 and a bridge circuit 43.

The data storage part 44 stores at least one control routine therein to process data received through the network controller 35. For example, the at least one control routine stored in the data storage part 44 may comprise an operating system to drive the data processor 40, and an application program to process various data received through the network controller 35.

Here, the application program may comprise a codec program to decompress graphics data received from the network controller 35 and compressed into a predetermined format, and a processing program to process the graphics data decompressed through the codec program.

The main processor 41 loads the control routine stored in the data storage part 44 to the memory 42 to execute the control routine. The main processor 41 may be provided as a one chip processor comprising a central processing unit (CPU), a memory controller to control the memory 42, and a graphics controller to process the video signal.

The video signal output by the main processor 41 is converted into the transition minimized differential signaling (TMDS) type second video signal through a transition minimized differential signaling (TMDS) transmitter 45 to be output to the video signal processor 32.

The bridge circuit 43 allows the data storage part 44 and the main processor 41 to exchange data with each other. The main processor 41 and the bridge circuit 43 may be connected with each other through a predetermined bus, for example, a peripheral component interconnect (PCI) bus 46.

Meanwhile, the controller 34 is connected with the bridge circuit 43 to receive the power saving mode conversion signal from the bridge circuit 43.

The power saving mode conversion signal is supplied to the controller 34 through the bridge circuit 43 if the main processor 41 satisfies predetermined conditions. For example, the main processor 41 may output the power saving mode conversion signal corresponding to the preset power saving mode through the bridge circuit 43 if the preset power saving mode supported by the operating system stored in the data storage part 44 is executed.

At this time, the controller 34 converts the display apparatus 30 into the preset power saving mode according to the received power saving mode conversion signal if the power saving mode conversion signal is received from the bridge circuit 43. For example, the controller 34 turns off the backlight unit 33c according to the received power saving mode conversion signal if the power saving mode conversion signal is received. Accordingly, the display apparatus 30 according to the present embodiment may reduce power consumption.

The main processor 41 supplies a normal mode conversion signal to the controller 34 through the bridge circuit 43 if, for example, the data processor 40 receives new input, after the controller 34 has converted the display apparatus 30 into the preset power saving mode according to the power saving mode conversion signal. The controller 34 converts the display apparatus 30 into a normal mode according to the normal mode conversion signal, e.g., turns on the backlight unit 33c.

Thus, the display apparatus 30 may be selectively converted into the preset power saving mode and the normal mode according to an operating state of the data processor 40.

Meanwhile, the data processor 40 according to the present embodiment may be driven by an operating system and an application program stored in the computer 10 (i.e. an external device connected through the network 20), instead of being driven by the operating system and the application program stored in the data storage part 44.

That is, the main processor 41 of the data processor 40 may execute the operating system and the application program of the computer 10, and may receive desired data, such as the graphics data, through the network 20. The data processor 40 may control the operating system or the application program by receiving a command through a keyboard or a mouse connected through a USB and by transmitting the command to the computer 10 through the network 20.

If the operating system of the computer 10 is converted into a predetermined power saving mode, (e.g., if a screen saver is activated) the main processor 41 may receive a first control signal corresponding to the predetermined power saving mode from the computer 10 through the network controller 35 and may supply the power saving mode conversion signal to the controller 34 corresponding to a reception of the first control signal.

If the computer 10 is converted from the predetermined power saving mode to an active mode (e.g., the screen saver is inactivated), the main processor 41 receives a second control signal corresponding to the active mode from the computer 10 through the network controller 35, and supplies the normal mode conversion signal to the controller 34 through the bridge circuit 43.

Accordingly, even if the data processor 40 operates based on the operating system or the application program of the computer 10, the display apparatus 30 may operate in the preset power saving mode and the normal mode.

Meanwhile, the controller 34 according to the present embodiment may operate in a first display mode to control the video signal processor 32 to display the first video signal input through the video input part 31 as the image on the display part 33, and in a second display mode to control the video signal processor 32 to display the second video signal output from the data processor 40 as the image on the display part 33.

Here, the controller 34 remains in the normal mode if the power saving mode conversion signal is received from the data processor 40 when the controller 34 operates in the first display mode. That is, the controller 34 allows the first video signal input through the video input part 31 to continue to be displayed as the image on the display part 33.

Conversely, the controller 34 converts the display apparatus 30 into the preset power saving mode if the power saving mode conversion signal is received from the data processor 40 when the controller 34 operates in the second display mode.

Also, the controller 34 may operate in the preset power saving mode according to a state of the first video signal input through the video input part 31 if the controller 34 operates in the first display mode. The preset power saving mode operated according to the state of the first video signal may comprise a display power management signaling (DPMS) of video electronics standard association (VESA).

Thus, the controller 34 of the display apparatus 30 according to embodiments of the present general inventive concept operates individually in the first display mode and the second display mode, thereby efficiently reducing power consumption according to the operating state of respective modes.

The embodiments of the present general inventive concept can also be embodied as computer readable codes on a computer readable recording medium. The computer readable recording medium may include any data storage device that can store data which can be thereafter read by a computer system. Examples of the computer readable recording medium include a read-only memory (ROM), a random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. The embodiments of the present general inventive concept may also be embodied in hardware or a combination of hardware and software. For example, the data processor 40 and the controller 30 may be embodied in software, hardware, or a combination thereof.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A display apparatus, comprising:
a display part;
a video signal processor to convert an input video signal into a format displayable by the display part;
a network controller connectable to a network and to transmit and receive data according to a predetermined protocol;
a data processor to process the data transmitted and received through the network controller and to output a predetermined power saving mode conversion signal; and
a controller to convert an operation mode of the display apparatus into a preset power saving mode when the predetermined power saving mode conversion signal is received from the data processor.

2. The display apparatus according to claim 1, wherein the display part comprises:
a liquid crystal display (LCD) panel; and
a backlight unit to emit light toward the LCD panel, and the controller turns off the backlight unit according to the received predetermined power saving mode conversion signal.

3. The display apparatus according to claim 2, wherein the controller converts the operation mode of the display apparatus into a normal mode if a normal mode conversion signal is received from the data processor when the display apparatus is in the preset power saving mode.

4. The display apparatus according to claim 3, wherein the data processor comprises:
a data storage part to store at least one control routine therein to process the data received through the network controller;
a memory to load the at least one control routine and an operating system;
a main processor to load the at least one control routine to the memory and to execute the at least one control routine; and
a bridge circuit to allow the data storage part and the main processor to communicate with each other.

5. The display apparatus according to claim 4, wherein the controller is connected to the bridge circuit, and the main processor selectively supplies the predetermined power saving mode conversion signal and the normal mode conversion signal to the controller through the bridge circuit.

6. The display apparatus according to claim 5, wherein the main processor supplies one of the predetermined power saving mode conversion signal and the normal mode conversion signal to the controller based on a predetermined control signal received through the network controller from an external device connected through the network.

7. The display apparatus according to claim 6, further comprising:
a video input part to receive a first video signal in a first predetermined format,
wherein the controller operates in a first display mode to control the video signal processor to display the first video signal on the display part, and operates in a second display mode to control the video signal processor to display a second video signal in a second predetermined format output from the data processor, on the display part.

8. The display apparatus according to claim 7, wherein the controller controls the display apparatus to remain in the normal mode if the predetermined power saving mode conversion signal is received from the data processor when the controller operates in the first display mode, and to convert into the preset power saving mode if the predetermined power saving mode conversion signal is received from the data processor when the controller operates in the second display mode.

9. The display apparatus according to claim 8, wherein the controller converts the display apparatus in the preset power saving mode according to a state of the first video signal input through the video input part while operating in the first display mode.

10. The display apparatus according to claim 9, wherein the preset power saving mode according to the state of the first video signal comprises a display power management signaling (DPMS) of video electronics standard association (VESA).

11. A video signal processing and control system usable with a display that displays video signals received from a network, the video signal processing and control system comprising:
a controller to receive first data from the network, to extract and transmit a first video signal included in the first data to the display, and to send a power save signal to the display depending on the first data.

12. The video signal processing and control system according to claim 11, wherein the controller sends the power save signal to the display when first predetermined conditions are satisfied, and when a power saving command is included in the first data.

13. The video signal processing and control system according to claim 11, wherein the controller sends a normal mode signal to the display after sending the power save signal when second predetermined conditions are satisfied, and when a normal mode command is included in the first data.

14. The video signal processing and control system according to claim 11, wherein the controller receives second data from at least one video input part and sends one of the first video signal and a second video signal included in the second data to the display.

15. The video signal processing and control system according to claim 14, wherein:
the video signal processing and control system operates in a first display mode when sending the first video signal to the display and in a second display mode when sending the second video signal to the display, and
the video signal processing and control system sends the power save signal to the display only when operating in the first display mode.

16. A display connected to a network, the display comprising:
a display part to operate in a normal mode displaying images according to video signals and in a power saving mode; and
a video signal processing and control unit to receive first data from the network, to extract a first video signal included in the first data, to send the first video signal to the display part, and to send a power save signal to the display part when first predetermined conditions are satisfied, and when a power saving command is included in the first data, and the display part converts to the power saving mode upon receiving the power save signal.

17. The display according to claim 16, further comprising: at least one video input part to transmit second data including a second video signal to the video signal processing and control unit, and the video signal processing and control unit extracts the second video signal from the second data and sends one of the first video signal and the second video signal to the display part.

18. The display according to claim 17, wherein the video signal processing and control unit converts the first video signal and the second video signal into a format displayable by the display part.

19. The display according to claim 17, wherein the video signal processing and control unit does not send the power save signal to the display part while sending the second video signal to the display part.

20. The display according to claim 16, wherein the video signal processing and control unit sends a normal mode signal to the display part after sending the power save signal when receiving new data from the network, and when receiving a normal mode command from the network.

21. The display according to claim 16, wherein the display part comprises:
a backlight unit to emit light;
an LCD panel selectively transmitting the light received from the backlight unit; and
a panel driver to drive the LCD panel according to the video signals.

22. The display according to claim 21, wherein the display part turns off the backlight when receiving the power save signal from the video signal processing and control unit.

23. The display according to claim 21, wherein the display turns back on the backlight when receiving a normal mode signal from the video signal processing and control unit after receiving the power save signal and turning off the backlight unit.

24. A computer readable medium containing executable code of to control a display connected to a network, the executable codes comprising:
a first executable code to receive data from the network and extract a video signal from the data;
a second executable code to transmit the video signal to the display; and
a third executable code to send a power save signal to the display depending on the first data.
